(19) United States
(12) Patent Application Publication
(10) Pub. No.: US 2011/0170291 A1
(43) Pub. Date: Jul. 14, 2011

(54) EFFICIENT AND UNIFORMLY DISTRIBUTED ILLUMINATION FROM MULTIPLE SOURCE LUMINAIRIES

(76) Inventor: Jerome H. Simon, Newton, MA (US)

(21) Appl. No.: 12/446,334

(22) PCT Filed: Dec. 27, 2006
(86) PCT No.: PCT/US06/49369

§ 371 Date: Nov. 9, 2010

Related U.S. Application Data
(63) Continuation of application No. 11/583,441, filed on Oct. 19, 2006, now Pat. No. 7,597,453.
Application No. 11/583,441 is a continuation-in-part of application No. 11/034,395, filed on Jan. 12, 2005, now Pat. No. 7,677,760.
(60) Provisional application No. 60/728,343, filed on Oct. 19, 2005.
(60) Provisional application No. 60/536,477, filed on Jan. 14, 2004.

(51) Int. Cl. F21V 29/00; F21V 13/04

(52) U.S. Cl. 362/241

(57) ABSTRACT

Light projecting luminaires and devices for integrating the light output from multiple light emitting quasi point sources into unified predetermined light patterns. The multiple light emitting quasi point sources are generally stacked with a common optical axis, each o the light emitting quasi point light sources further surrounded by a ring collimator designed to collect and project a radial beam of light away from the optical axis. The ring collimator can be a canted off axis ring lens that projects a canted radial beam away from the axi A series of individual collimators can form a multibeam collimator surrounding each of the light emitting sources and substituting for the ring collimator forming an array of beams projected away from the optical axis. Either of the systems may use reflecting surfaces to intercept and redirect the radiating collimated light into distribution patterns ranging from focused beams to ambient broad light distribution.

### FIELD OF INVENTION

The present invention relates generally to the field of lighting and, more particularly, to arrangements of quasi-point light sources, such as LEDs, used in an efficient manner and to providing homogenized light from multiple light sources.

### SUMMARY OF THE INVENTION

An object of this invention is to create a unified beam pattern from multiple quasi point sources such as LEDs, Halogen or HID lamps. Another object of this invention is to mix color from groupings of multicolored light sources. A further object of this invention is to integrate the light from multiple quasi point sources into high intensity collimated beams. Still another object of this invention is to efficiently focus the light from multiple quasi point sources into light guides. Still a further object of this invention is to provide uniformly distributed illumination over large architectural surfaces. Yet another object of this invention is to provide brightly illuminated and light projecting grids and surfaces.

These light projecting devices are for integrating the light output from multiple light emitting quasi point sources into unified predetermined light patterns. The multiple light emitting quasi point sources (such as LEDs [Light Emitting Diodes]) are generally stacked with a common optical axis, each of the light emitting quasi point light sources further surrounded by a ring collimator designed to collect and project a radial beam of light away from the optical axis. In some embodiments, a series of individual collimators surround each of the light emitting quasi point sources and substitutions for the ring collimator forming an array of beams projected away from the optical axis. Further, either of the systems, whether incorporating a ring collimator or a series of individual collimators, may use reflecting surfaces to intercept and redirect the radiating collimated light into distribution patterns ranging from focused beams to ambient broad light distribution.

The present invention provides uniform surface illumination from a luminaire containing multiple light sources and homogenized light from multiple light sources.

The present invention further provides sharp cutoff at any desired angle from a luminaire containing multiple light sources.

Also, the present invention provides mixed color from different colored light sources.

Further, the present invention provides broad evenly distributed illumination from a luminaire containing multiple light sources.

### BRIEF DESCRIPTIONS OF DRAWINGS

These and other objects, features and advantages will be apparent from the following detailed description of preferred embodiments taken in conjunction with the accompanying drawings in which:

FIG. 1: illustrates an LED mounted to an electrical contact base.

FIG. 1A: is a cross-sectional drawing of FIG. 1.

FIG. 1C: illustrates two LEDs with the electrical contact base mounted back-to-back to each other.

FIG. 1D: illustrates two LEDs mounted back-to-back sharing the same electrical contact base.

FIG. 1E: illustrates two LEDs mounted on a transparent electrical contact base.

FIG. 1F: illustrates several LEDs mounted on opposite sides of a common electrical contact base.

FIG. 2: illustrates three LED modules, each sharing the same optical axis.

FIG. 3A: is a cross-sectional view of an LED surrounded by an off-axis ring collimator.

FIG. 3A1 is an isometric view showing an LEDM module shown in FIG. 3A.

FIG. 3B: is a variation of 3A.

FIG. 3C: is a further variation of 3A.

FIG. 4A: illustrates an LED surrounded by a compound ring collimator.

FIG. 5: illustrates a stack of LEDs, each surrounded by a ring collimator.

FIG. 6: illustrates a variation of FIG. 5.

FIG. 7: further illustrates a variation of FIG. 5.

FIG. 8: further illustrates a stack of LED modules, each surrounded by a ring collimator, further surrounded by a reflecting ring.

FIG. 8A: is a variation of FIG. 8.

FIG. 8B: illustrates the focus of light in FIG. 8A entering a light guide.

FIG. 9: illustrates a variation to FIG. 8, each composite LED and ring collimator sharing a common reflecting surface.

FIG. 10: is a variation of FIG. 9.

FIG. 11: is a variation of FIG. 8.

FIG. 11A: is a further variation of FIG. 8.

FIG. 11 B is similar to FIG. 11.

FIG. 12: is a further variation of FIG. 8, having all reflector rings sharing the same fabricated body.

FIG. 13: is a cross-section of an LED surrounded by a multiple direction collimator.

FIG. 13A: illustrates a bi-directional collimator, as in FIG. 13.

FIG. 13B: illustrates a 4-way directional collimator as in FIG. 13.

FIG. 14: illustrates a variation in the collimator of FIG. 13.

FIG. 14A: is a three-dimensional view of a 4-way collimator shown in FIG. 14.

FIG. 15: is a three-dimensional diagram of a luminaire designed to create a pattern of projected beam segments.

FIG. 15A: is a plan diagram of FIG. 15.

FIG. 15B: is a variation of FIG. 15A.

FIG. 16: is a variation of FIG. 15.

FIG. 17: illustrates an LED surrounded by a ring collimator projecting into light guides.

FIG. 17A: is a cross-sectional variation of FIG. 17.

FIG. 17 B is an assembly similar to FIGS. 17 and 17A.

FIG. 18: illustrates a stack of LEDs surrounded by multiple beam collimators projecting into a light guide.

FIG. 18A: is a plan view of FIG. 18.

FIG. 20: is a cross-sectional diagram of a reflective and refractive container surrounding LED and collimating ring composites.

FIG. 20A: is a variation of FIG. 20.

FIG. 21: is a cross-sectional view of a multi-tiered luminaire comprised of light collimation modules and light pathways.

FIGS. 21A, 21B, 21C, and 21D: are variations of FIG. 21.

FIG. 21E: is a cross-sectional view of a beam modifying panel that can be used with luminaire shown in FIGS. 20, 202A, 21B, 21C, and 21D.

FIG. 22: is a cross-sectional view of a unified optical body.

FIG. 22A: is a variation of FIG. 22.

FIG. 23: is a group of stacked components as illustrated in FIG. 22.

FIG. 24: is a three-dimensional view of disk shaped unified optical body.

FIG. 24A: is a variation of FIG. 24.

FIG. 25 is an isometric view of a luminaire.

FIG. 25A: is a variation of FIG. 25.

FIG. 26: is a variation of FIG. 25.

FIG. 27: is a cross-sectional diagram of the optical components of a luminaire comprised of a single quasi point light surrounded by a collimating lens and a ring reflector for projecting broadly distributed illumination.

FIG. 27A: is a cross-sectional diagram of the optical components of a luminaire comprised of multiple quasi point light sources, each surrounded by collimating ring lenses and a ring reflector.

FIG. 27B: is a cross-sectional diagram similar to FIG. 27a wherein the ring reflectors are curved in section.

FIG. 27C: is a cross-sectional diagram similar to FIG. 27b further comprising refracting rings.

FIG. 27D: is a cross-sectional diagram similar to FIG. 27b wherein the ring reflectors are canted at different angles in section.

FIG. 28: is a cross-sectional diagram of an off axis radial beam collimator comprised of a quasi point light source surrounded by off axis ring collimator.

FIG. 28A: is a cross-sectional diagram similar to FIG. 28 comprising multiple quasi point light sources each surrounded by an off axis ring collimator and further comprised of heat sinks.

FIG. 28B: is a cross-sectional diagram similar to FIG. 28a wherein the quasi point light sources are located at differing distances from each other.

FIG. 29: is a cross-sectional diagram similar to FIG. 28 wherein the off axis collimating ring lens is further surrounded by a ring reflector.

FIG. 29A: is a cross-sectional diagram similar to FIG. 28a wherein the off axis collimating ring lenses are further surrounded by ring reflectors.

FIG. 30: is a cross-sectional diagram similar to FIG. 28a wherein the off axis collimating ring lenses are further surrounded by refracting rings which in section function as wedge prisms.

FIG. 30A: is a cross-sectional diagram similar to FIG. 30 wherein the angles of wedge prisms are different in each prism ring.

FIG. 31: is a cross-sectional diagram similar to FIG. 27a further comprising a second ring reflector.

FIG. 32: is a

FIG. 33: is a cross sectional diagram similar to FIG. 27a wherein the ring reflector is comprised of two conical segments.

FIG. 34: is an elevation view diagram of a luminaire comprised of radial light projecting modules located at varying distances along the luminaire.

FIG. 35: is an elevation view diagram of a luminaire similar to that in FIG. 34 wherein the radial light projecting modules are substantially spaced equally.

FIG. 36: is an elevation view diagram of a luminaire similar to that in FIG. 34 wherein each module projects a radial beam, each beam being projected a substantially the same angle.

FIG. 37: is a perspective view of a room containing radially projecting luminaires positioned and located to illuminate various areas of the room.

FIG. 38: is a cross-sectional view of a luminaire illustrating air flow through a stack of combined multiple quasi point light sources and the heat sinks to which they are attached.

FIG. 38A: illustrates a type of heat sink that be used in FIG. 38.

FIG. 38B: illustrates a variation of the heat sink described in FIG. 38a.

FIG. 38C: illustrates still another variation to the heat sink described in FIG. 38a.

FIG. 38D: illustrates a variation to the heat sink shown in FIG. 38b.

FIG. 38E: illustrates a type of heat sink that can be used in 38 wherein the heat sink comprises a reflector portion.

FIG. 40: is a three dimensional view of a luminaire comprising multiple beam collimators projecting beams through channels created by fins of a heat sink structure within which the multibeam collimators are located.

FIG. 40A: is a cross sectional view of FIG. 40.

FIG. 40B: is a cross sectional view of FIG. 40 illustrating a variation in the multibeam collimator.

FIG. 40C: is a cross sectional view of a luminaire similar to that shown in FIG. 39 having a different cross section.

FIG. 40D: is a cross sectional view of FIG. 40 comprising a different collimator.

FIG. 41 is a cross sectional view of a light projecting device comprised of LEDs, heat sinks and a refracting surface.

FIG. 41A is a detail of the refracting surface shown in FIG. 41.

### DETAILED DESCRIPTION OF THE DRAWINGS

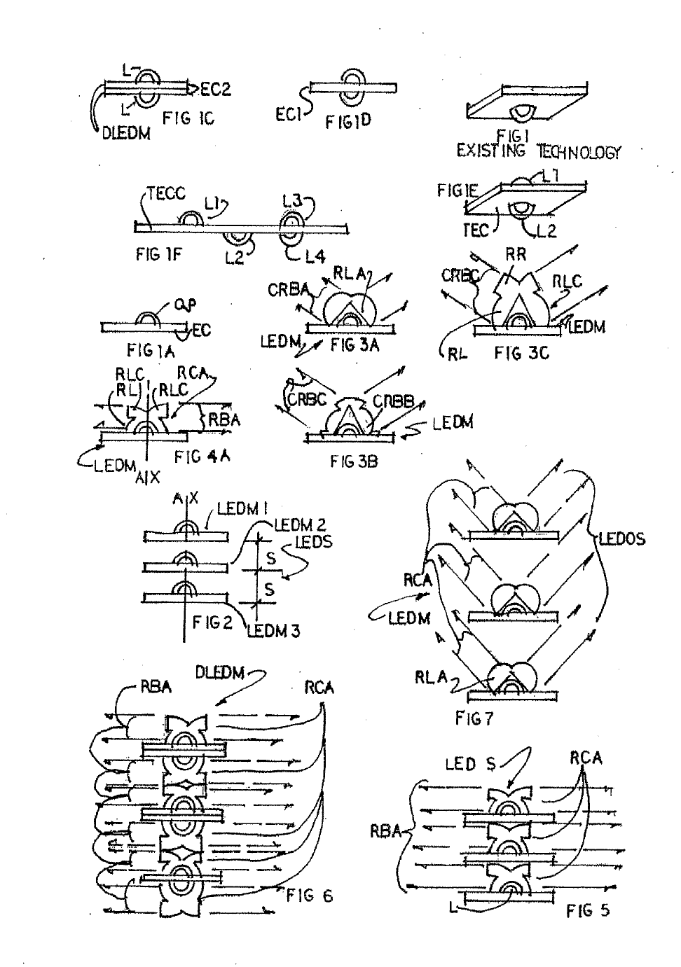

FIG. 1 shows an LED (light emitting diode) module LEDM having an electrical contact base EC and a light emitting diode L. This is existing technology.

FIG. 1A shows an LED module as illustrated in FIG. 1 showing the location of the quasi-point light emitting surface QP of the LED.

FIG. 1C illustrates two LEDM modules DLEDM having their electrical contact base EC mounted back to each other. Their light emitting diode surfaces C at substantially 180° to each other.

FIG. 1D illustrates a variation to FIG. 1C which is that both L components share the same electrical contact base EC1.

FIG. 1E is similar to FIG. 1D differing in that the electrical component base EC1 of FIG. 1D is comprised of a transparent material TEC of FIG. 1E so that L1 and L2 are visible simultaneously though TEC.

FIG. 1F shows a continuous transporting electrical contact base having several L components sharing the same place both above L1 and L3 and below L2 and L4.

FIG. 2 shows three LEDM modules stacked above each other sharing axis AX. The distance S between the modules LEDM1, LEDM2 and LEDM3 vary between the modules.

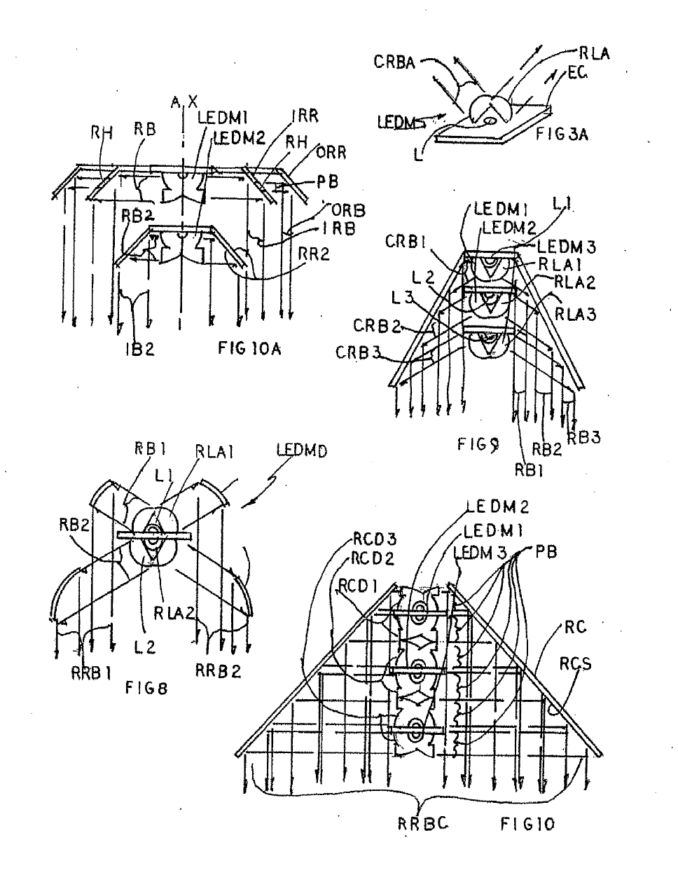

FIG. 3A illustrates an LEDM at least partially surrounded by a radial off axis radially collimating ring lens RLA projecting canted radial beam CRBA.

FIG. 3A1 shows an LEDM module as described in FIG. 3A comprised of an EC, an L, and an RLA projecting a CRBA.

FIG. 3B illustrates an LEDM at least partially surrounded by an off axis ring lens CRBB having a Fresnel cross-section projecting canted radial beam CRBC.

FIG. 3C illustrates an LEDM at least partially surrounded by a radial off axis collimator RLC. RCL is comprised of a plano convex, double convex, or concave convex off axis ring section RL and an internally reflective surface RR which is substantially parabolic in section. RLC projects canted radial beam CRBC.

FIG. 4A illustrates an LEDM module at least partially surrounded by a compound ring collimator RCA comprised of a ring lens RL (the cross-sectional of which is described in FIG. 3C). Radial beam RBA emanating from RCA is substantially perpendicular to axis AX.

FIG. 5 illustrates a stack of LEDM modules LEDSS as described in FIG. 2 as LEDM1, LEDM2 and LEDM3. Each LED at least partially surrounded by a ring collimator RCA (described in FIG. 4) each projecting a radial beam RBA which. Each L may be of the same or different color and the number LEDM module can be of any number. This is true of all figures showing multiple L in this filing.

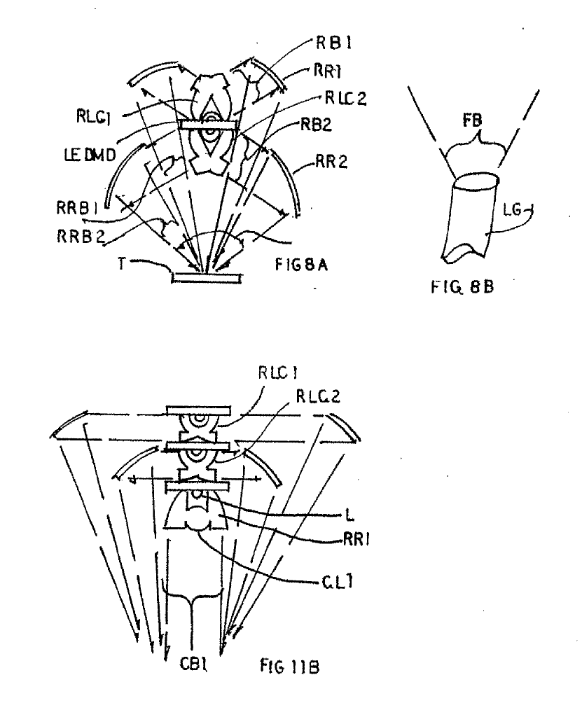

FIG. 6 illustrates a stack of DLEDM modules (as described in FIG. 1C) LEDSD (as described in FIGS. 1C and 1D). Each DLEMD is at least partially surrounded by a composite ring collimator RVA projecting a radial beam as described in FIG. 4A.

FIG. 7 illustrates a stack of LEDM modules LEDOS of which each L is at least partially surrounded by a radial off axis ring collimator (as described in FIG. 3A, 3B, or 3C) projecting radial off axis canted radial beams RCA.

FIG. 8 illustrates an LEDMD module comprised of a single EC having back to back component L1 and L2 respectively further surrounded by reflector rings R1 and R2 which are substantially conical. The sections of which are canted as to reflect the radial off axis beams RB1 and RB2 in the same direction as parallel tubular shaped beams RRB1 and RRB2. RR1 and RR2 can be canted so as to focus RRB1 an RRB2 onto a shared target area. This is further described in FIG. 8A

FIG. 8A illustrates an LEDMD module similar to that illustrated in FIG. 8. L1 and L2 at least partially surrounded by a composite ring collimator RCL1 and RCL2 respectively (as described in FIG. 3c) further surrounded by ring reflectors RR1 and RR2 respectively reflecting canted radial beams RB1 and RB2 as conical beams RRB1 and RRB2 that overlap and focus as FB on target area T. T can be transparent, translucent, or have refracting surfaces, or be the entry to a light guide LG, as in FIG. 8B.

FIG. 8B illustrates the focused Beam FB created by the optical configuration described in FIG. 8A entering into light guide LG. LG can be a fiber optic or a reflecting tube.

FIG. 9 illustrates a stack of LEDM modules LEDM1, LEDM2, LEDM3 (as illustrated in FIG. 3). Each L (L1, L2, L3) is at least partially surrounded by a radial off axis radial collimating lens respectively projecting radial canted beams CRB1, CRB2, CRB3 respectively onto and reflected off reflective surface RCS of substantially conical reflector RC as tubular conic beams RRB1, RRB2 and RRB3 respectively.

FIG. 10 illustrates a stack of LEDM modules (similar to shown in FIG. 6 having ring collimators RCD1, RCD2 and RCD3) LEDM1, LEDM2 and LEDM3 projecting a vertical stack of radial beams CPB onto and reflected by RCS of RC as tubular concentric beams RRBC. The narrow diameter reflector RC is minimal, only large enough to allow the reflected radial beams to not be obstructed by the LEDM radially projecting modules

FIG. 10A a stack of two LEDM Radial beam modules, LEDM1 and LEDM2 respectively that share the same optical axis AX. LEDM1 projects radial beam RB onto reflector ring IRR. Reflector ring IRR having radially disposed openings RH reflects radial beam RB as reflected beam IRB allowing a portion of RB to pass through as radially disposed beam portions RH. Radially disposed beam portions PB are in tern reflected by reflector ring ORR as reflected beam segments ORB. Reflector ring ORR at least partially surrounds reflector ring IRR. Radial beam projecting module LEDM2 projects radial beam RB2 onto and is redirected by ring reflector RR2 as redirected beam IB2. The diameters of reflector rings IRR ORR and RR2 can such that in beam IB2 can be within, between or surround beams IRB and ORB.

FIG. 11 illustrates a stack of LEDM modules (as illustrated in FIG. 5). LEDM1, LEDM2 and LEDM3 at least partially surrounded by composite ring collimators RLC1, RLC2 and RLC3 projecting radial beams CRB1, CRB2 and CRB3 respectively onto and be reflected by reflector rings RR1, RR2 and RR3 as radial conical beams CFB1, CFB2, and CFB3 toward and onto a common target T as a focused beam FB.

FIG. 11A is similar to that of FIG. 11 differing in that the cross-section of RR1 is concave reflecting CRB1 as CFB1 as having converging rays, the cross-section of RR2 is flat reflecting CRB2 as CFB2 the rays of which remain equally divergent to CRB2. RR3 is convex reflecting CFB three as divergent rays CFB3.

FIG. 11B is similar to FIG. 11 differing in that RLC3 of FIG. 11 has been replaced with RR1, an optical collimator comprised of a parabolic reflective surface PRS and a convex surface CLS combining to collect and project beam CB1 L can be halogen or meal halide or any other quasi point source. RR1 can be a simple parabolic or elliptical reflector.

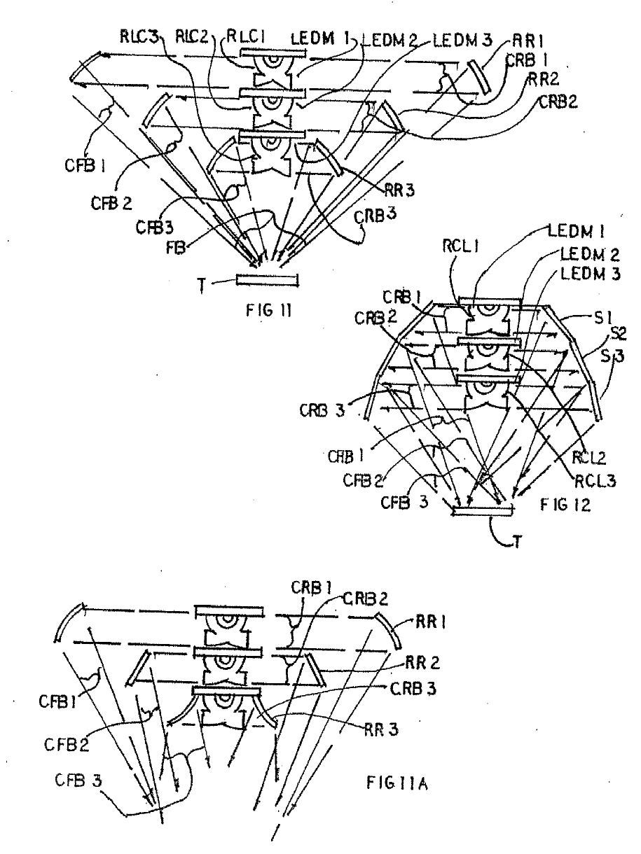

FIG. 12 illustrates a stack of LEDM modules (as illustrated in FIG. 5) at least partially surrounded by composite ring collimators RLC1, RLC2 and RLC3 respectively projecting radial collimated beams CRB1, CBR2, and CRB3 onto ring segments S1, S2, and S3 of reflector cone CR. S1 reflects and focuses CRB1 as CFB1 onto target area T, S2 reflects and focuses CRB2 as CFB2 onto target area T, S3 reflects and focuses CRB3 as CFB2 onto target area T. Focused beam FB is a composite of focused beams CFB1, CFB2 and CFB3. T can be replaced by the entry face of a solid or hollow light guide as illustrated in FIG. 8B.

FIGS. 8A, 8B, 11 and 12 illustrate mean of additive brightness, or color mixing, or color selectivity on a target area or entry to a light transmission means.

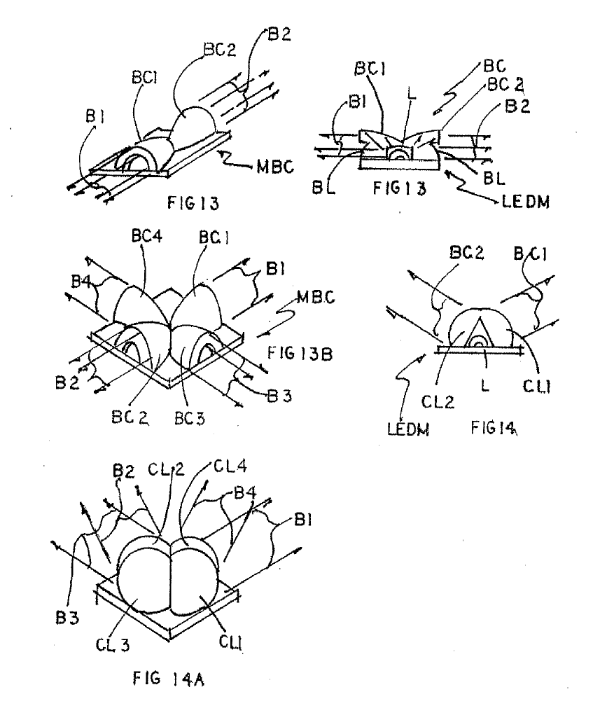

FIGS. 13 and 13A show a multiple beam collimator comprised of an LEDM module with L at the focal length of a bidirectional collimator BC each half, BC1 and BC2 comprised of a substantially parabolic reflector PR and a lens segment BL, the section of which is described in FIG. 4A. BC1 and BC2 gather approximately one half of the light from L and direct it as collimated beams B1 and B2.

FIG. 13B shows a four way multiple beam collimator MBC comprised of four light collection elements BC1, BC2, BC3, and BC4 each having optics similar to those illustrated in FIG. 13 and at substantially at 90° to each other each projecting a beam, B1, B2, B3 and B4 especially.

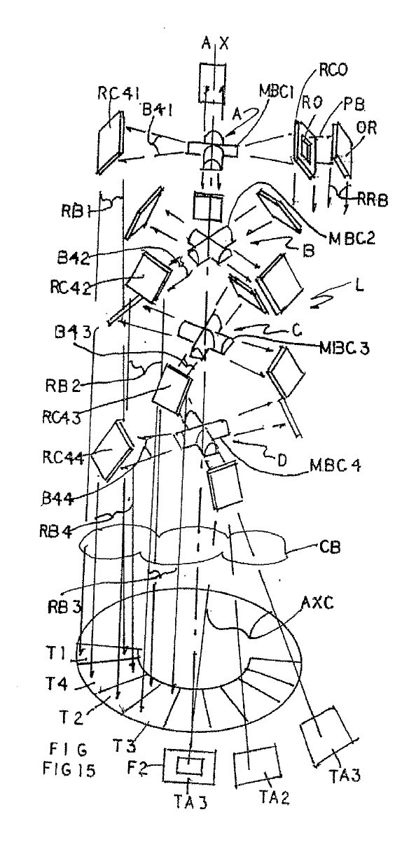

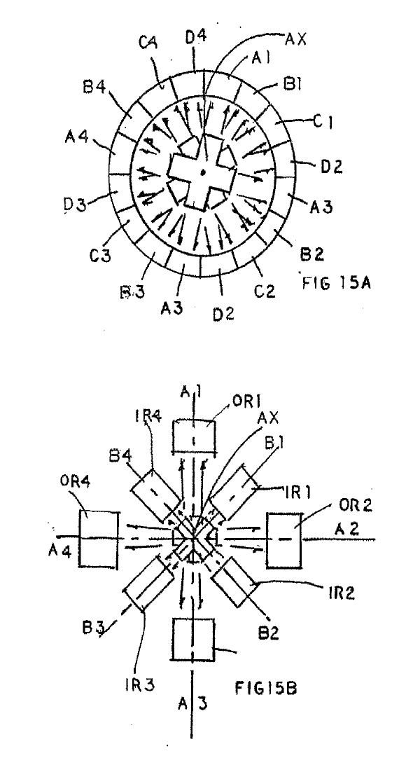

FIGS. 14 and 14A show a multiple beam collimator MBC comprised of LEDM modules and three or more collimating lenses (the sections of which are described in FIG. 3A). For graphic purposes only two lenses are shown in FIG. 14 CL1 and CL2, each projecting a canted collimated beam BC1 and BC2 respectively. FIG. 14A illustrates for collimating lenses CL1, CL2, CL3, and CL4 disposed at substantially 90° to each other projecting collimated beams B1, B2, B3 and B4 respectively.

FIG. 15 is a luminaire L designed to project and create a pattern of beams that are projected from multiple beam projectors that are stacked and with a radial offset form one another. Each multiple beam module as (described in FIGS. 13/13A/13B/14/14A) MBC1, MBC2, MBC3 and MBC4 has is comprised of four beam projecting collimators disposed at 90° that project typical beams B41, B42, 1343 and B44 respectively onto reflectors. The combined optical components MBC1 and RC41, MBC2 and RC42, MBC3 and RC43, and MBC4 and RC44 are labeled A, B, C and D respectively. In the illustrated luminaire of FIGS. 15, A, B, C, and D are rotated about vertical axis AX at 22½. The number of multiple beam modules the number of beam collimators within each module and the degrees of rotation from each other can vary from luminaire to luminaire. Also the color of the LED or other type of quasi point source within each module may vary from module to module. Typical beam B41, reflected by RC41 as Beam RB1 onto target area T1. In the same way B42 is reflected by RC42 as Beam RB2 onto target area T2, B43 is reflected by RC43 as Beam RB3 onto target area T3, B44 is reflected by RC44 as Beam RB4 onto target area T4 thus forming a circular cross-sectional pattern by composite beam CB. Any of the R reflectors can be tilted at an angle other that 90° to its associated beam causing the axis of the beam to be tilted along a radial axis of CB toward or away from AX. Also the distance of the reflectors R from the axis AX that surround the multibeam modules can differ from reflector to reflector. This is illustrated by the center angles AXC of a reflected beam shown to strike either of the three target areas TA1, TA2 or TA3, or any position in between. All the RB beams can therefore be focused upon a single target FT, or be projected into a light guide as illustrated in FIG. 8B. Also the cross-section of RC41, RC42, RCF3 and RC44 can be concave, convex or flat causing the cross-section of RB1, RB2, RB3 and RB4 to converge, divide or remain unchanged. One reflector RC42 is shown to have an opening RO through which a portion of individual beam B42 passes through as individual beam portion PB onto and is reflected by reflector OR as reflected by RRB.

FIG. 15A illustrates the radial relationship between A, B, C, and D of FIG. 15. The beam axis's of A lie on radii A1/AX1, A2/AX2, A3/AX3 and A4/AX4. The beam axis's of B lie on B1/AX, B2/AX, B3/AX and B4/AX. The beams of axis's C lie of C1/AX, C2/AX, C3/AX and C4/AX. The beam axis's of D lie on D1/AX, D2/AX, D3/AX and D4/AX.

FIG. 15B is a luminaire similar to that described in FIG. 15, modified in that only two multiple beam projecting modules are stacked on axis AX. In FIGS. 15/15A all reflectors are on the same circumference while in FIG. 15B reflectors OR1, OR2, OR3 and OR4 on axis A1/AX, A2/AX, A3/AX and A4/AX lie on a circumference having a greater diameter than reflectors IR1, IR2, IR3, and IR4 on axis B1/AX, B2/AX, B3/AX and B4/AX. The patters of reflector location shown in FIGS. 15/15A/15B can be altered in relationship to the number of beam projecting components in each beam module and the number of modules used in a stack. Reflectors can be fabricated in a uniform structural body.

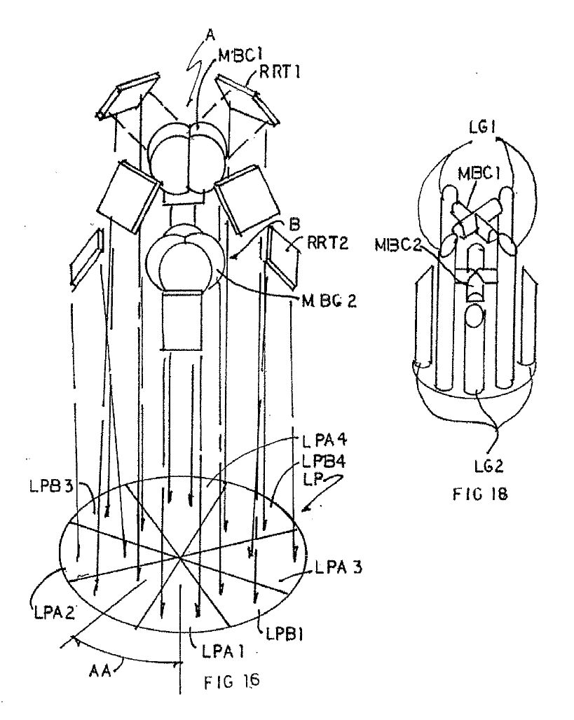

FIG. 16 illustrates a luminaire similar in function to that of FIG. 15. FIG. 16 shows two four multiple beam collimators (having similar optical configurations as shown in FIG. 14/14A) MBC1 and MBC2 each surrounded by sets of four mirrors RRT1 and RRT2 respectively. The combined optical composite of MB1 and RRT1, and MB2 and RRT2 are represented by A and B respectively. A and B are rotated at angle AA which is 45°. The resulting beam pattern LP is LPA1, LPA2, LPA3 and LPA4 projected by A, and LPB1, LPB2, LPB3 and LPB4 projected by B.

FIG. 17 shows an LEDM module (as illustrated in FIG. 13/13A/13B) projecting typical beam EB into the typical entry face ENF of hollow or solid typical light guide LG having a reflective or internally reflective typical surface R bending EB as typical beams RB through and out typical exit face EF as typical beams EXB.

FIG. 17A is an optical assembly similar to that shown in FIG. 17 illustrating a cant in the typical exit face EFC represented by angle A causing exit beams EXB to be bent toward and onto target T.

FIG. 17B is an optical assembly similar to that shown in FIGS. 17/17A illustrating a convex surface CC shared by typical exit face EFC bending and focusing typical EXB forming a focused beam FB onto target T.

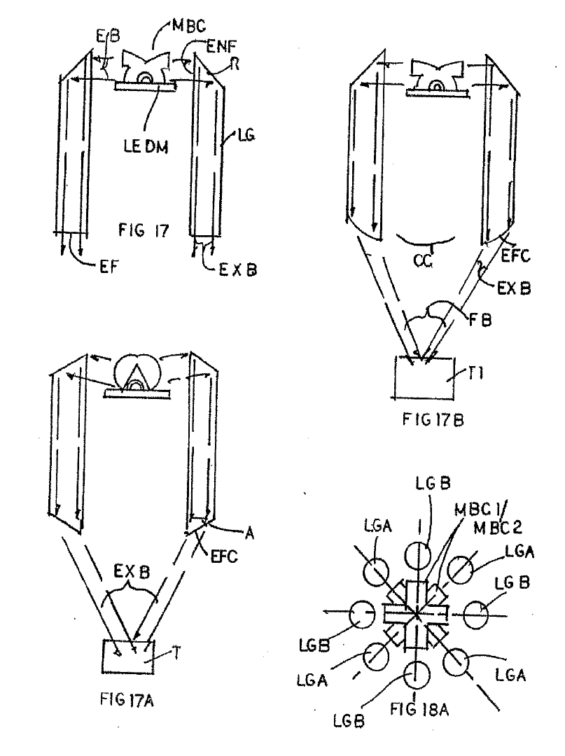

FIG. 18 is a diagram incorporating the function of FIG. 17 with the possible integration of FIGS. 17A/17B. Two multiple beam collimators MBC1 and MBC2 are stacked with a radial offset as in FIGS. 15/15A/15B/15C/16. Both MBC1 and MBC2 have corresponding groups of light guides LG1 and LG2. The eight light guides illustrated can be fabricated, extruded or molded as a unified structure.

FIG. 18A is a diagram of FIG. 18 illustrating MBC1 and MBC2 with a radial offset surrounded by light guide grouping LGA and LGB respectively.

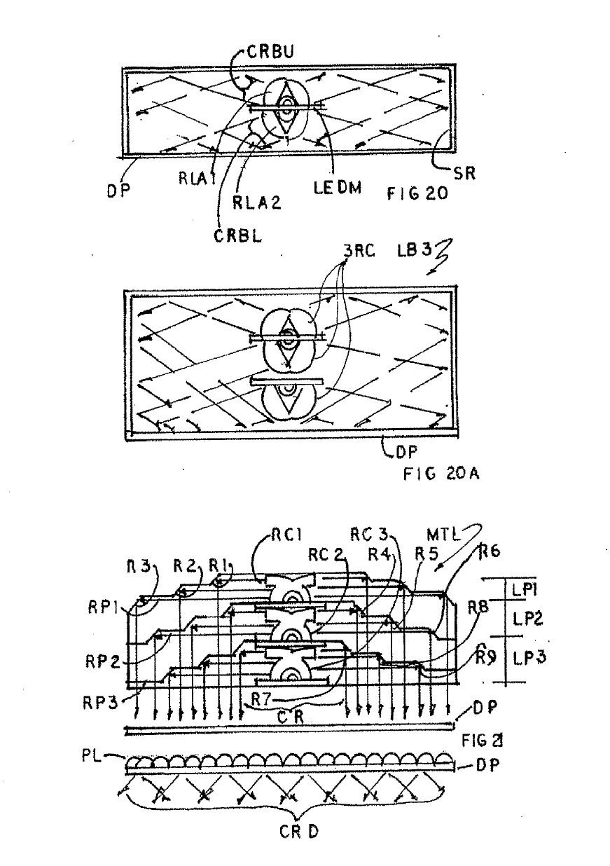

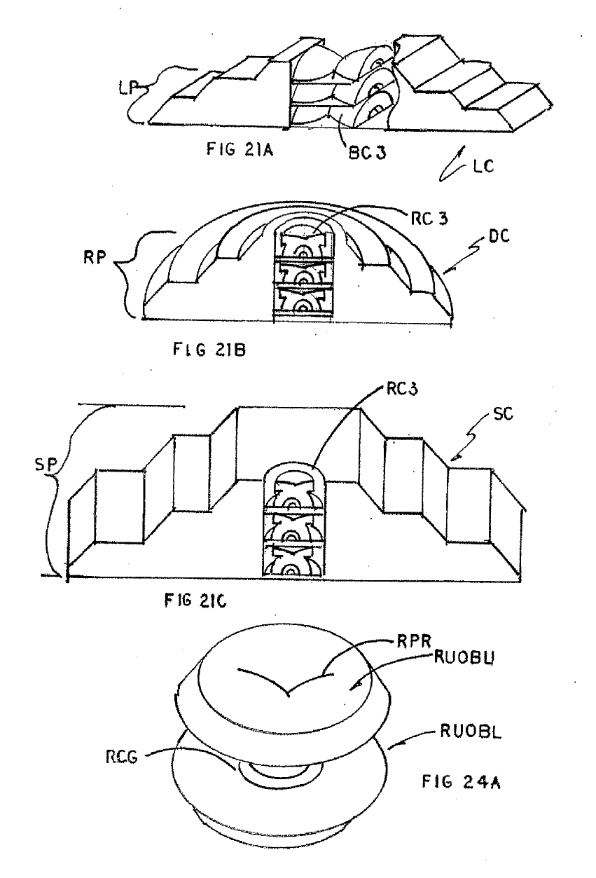

FIG. 20 is a diagram containing a LEDMD module and radial lenses RLA1 and RLA2 (similar to the same module and ring lenses of FIG. 8) enclosed in a rectangular or cylindrical container LB2, having an upper reflective surface UR, and a side reflecting surface which reflects conical redial beam CRBU onto diffusion surface DP. Conical radial beam CRBL is also projected onto DP overlapping CRBU.

FIG. 20A is a diagram similar to that for FIG. 20 differing in that LBL contains a stack of three ring collimators 3RC.

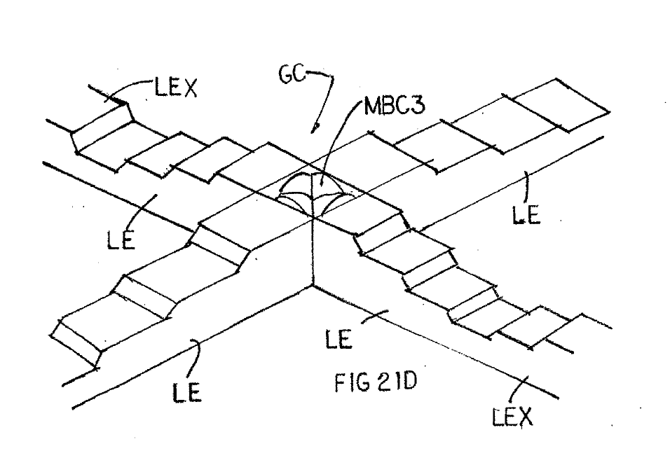

FIG. 21 is a view of four types of multi-tiered luminaire, a round planar luminaire illustrated in FIG. 21B, a linear luminaire illustrated in FIG. 21A or a grid type luminaire illustrated in FIG. 21D, a square (rectangular) planar luminaire illustrated in FIG. 21C, a stack of light collimating modules RC1, RC2, and RC3 that can (be of the type illustrated in FIGS. 13/13A/13B/14/14A or those having cross-sections similar to those illustrated in FIGS. 3A/3B/3C/4A/4B) project collimated beams B1, B2, and B3 respectively into and through light pathways LP1, LP2, LP3 respectively. The upper surface of LP1, LP2, LP3; RP1, RP2, and RP3 are internally reflective and are substantially parallel to B1, B2, B3 and are stepped at intervals forming canted reflective surfaces R1, R2, and R3, R4, R5, and R6, and R7, R8 and R9 respectively that segment B1, B2 and B3 respectably. The spacing intervals between R1, R2, and R3, R4, R5, and R6, and R7, R8 and R9 are such that as they intercept and reflect B1, B2 and B3 they do not block the reflected light from the other canted reflectors. The composite light from reflected beams B1, B2 and B3 is represented by rays CR. Accessory plate DP can be used to diffuse or modify CR if required.

FIG. 21A is a luminaire in a linear configuration LC comprised of a stack of three double beam collimators BC3 as part of an optical system LP having a similar sectional configuration and function as that of FIG. 21.

FIG. 21B is a luminaire DC in a circular disk configuration comprised of a stack of three radial collimators RC3 as part of an optical system RP having a similar sectional configuration and in function to that FIG. 21.

FIG. 21C is a luminaire SC having a planar rectangular shape comprised of a stack of three radial collimators RCS as part of an optical system SP having a similar sectional configuration and function to that of FIG. 21.

FIG. 21D is a luminaire GC in the form of intersecting linear configurations similar to LC of FIG. 21A differing in that of a stack of three four beam collimator (FIG. 13A) is at the intersections of the linear elements LE. Elements LE are shown joining to elements LEX which are the ends of other GC luminaire thus forming a grid of GC luminaire. The sections though, and functions of GC are similar to that of the section shown in FIG. 21.

FIG. 21E is a diffusion plate DP as described in FIGS. 20 and 20A having either V groves, pyramid prisms or concave or convex pillow lens type surfaces, PL diffusing beams CRBL of FIG. 20 as diverging ray CRD.

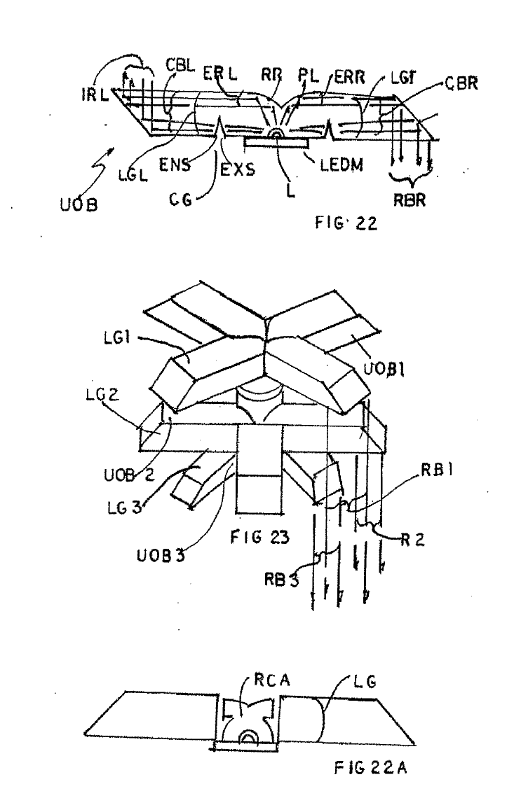

FIG. 22 is a unified optical body UOB at least partially surrounding L of LEDM. Rays ERR (on the right side of the diagram) and rays ERL (on the left side of the diagram) emanate from the upper portions L are reflected by parabolic surface PL and RR respectively and, EFF and ERL emanating from the side of L are refracted by collimating gap and combine to form collimated beams CBR and CBC respectively. Collimating gap CG is comprised of an exit surface EXS (that can be flat canted or convex) and an entry face ENS (that can be flat canted or convex in section). Combined collimated rays CBR and CBL pass though light guides LOT and LGL respectively. CBR and CBL are reflected by internal reflective surfaces IRR and IRL (which can be flat convex or concave in section). In this figure IRR and IRL are facing in opposite directions, therefore CBL is reflected by IRR and IRL can be changed in the same direction and therefore RBR and RBL would be projected in the same direction.

FIG. 22A is an alternate cross-section to that shown in FIG. 22 comprised of optical elements RCA which is described in FIGS. 3A1, 4B, 13, 13A, 13B and a light guide LG similar in function to that of LGR in FIG. 22.

FIG. 23 is a luminaire L comprised of three optical configurations UOB1, UOB2 and UOB3 each with a cross-section similar to shown in FIG. 22. UOB1, UOB2 and UOB3 are shown to have four light guide arms shown typically as LG1, LG2 and LG3 although the number of light guide arms is not restricted to four. As described in FIG. 15/15A/16/18, the light guides LG1 and LG2 have a radial offset from each other and as in FIG. 15B, LG3 is concentrically offset from LG1 and LG2. Radial or concentric “offsets” keep optical components such as light guides or reflectors from interrupting typical reflected beams RB1, RB2 and RB3. Although this figure illustrates three stacked optical configuration UOB1, UOB2 and UOB3 more or less can be used.

FIGS. 24 and 24A show an upper view RVOBU and a lower view RVOBL of a disk shaped optical configuration having a cross-section and function similar to that shown in FIGS. 22/22A. RUOBU illustrates radial parabolic form RPR and RUOBUL shows radial refractive surface RCG.

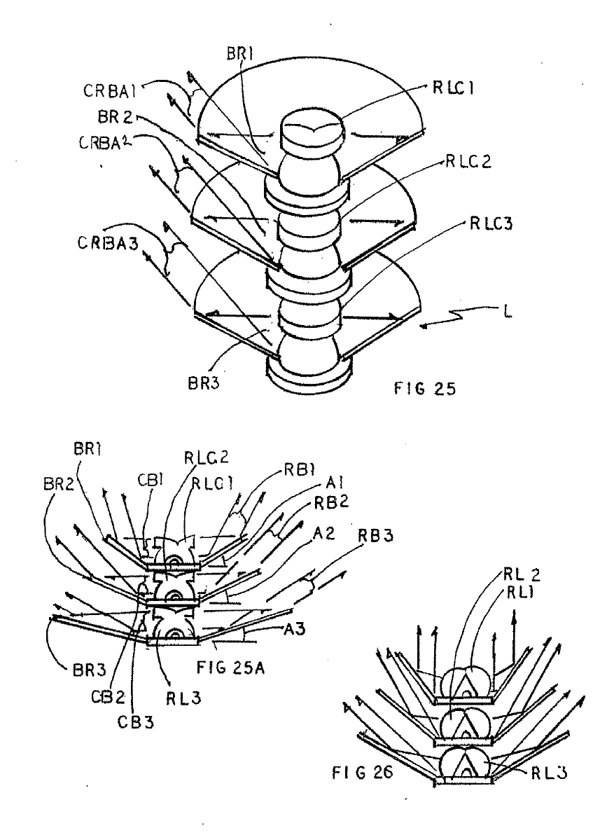

FIG. 25 is a cutaway three dimensional diagram of a luminaire L comprised of a stack of three modules RLC1, RLC2 and RLC3 similar in components and function to that shown in FIG. 5. RLC1, RLC2 and RLC3 are each at least partially surrounded conical reflectors BR1, BR2 and BR3 respectively, each reflecting radial light emanating from RLC1, RLC2 and RLC3 as canted radial beams CRBA1, CRBA2 and CRBA3 respectively.

FIG. 25A is a luminaire L similar to L of FIG. 25 differing in that the cant angles A1, A2, and A3 of conical reflectors BR1, BR2 and BR3 are progressively more acute reflecting radial beams CB1, CB2 and CB3 as progressively more obtuse to the center axis CA of RLC1, RLC2 and RLC3.

FIG. 26 is a luminaire L similar in cross-section and function to L of FIG. 25A differing in that RLC1, RLC2 and RLC3 of FIG. 25A has been replaced by RL1, RL2 and RL3 which are components described in FIG. 7.

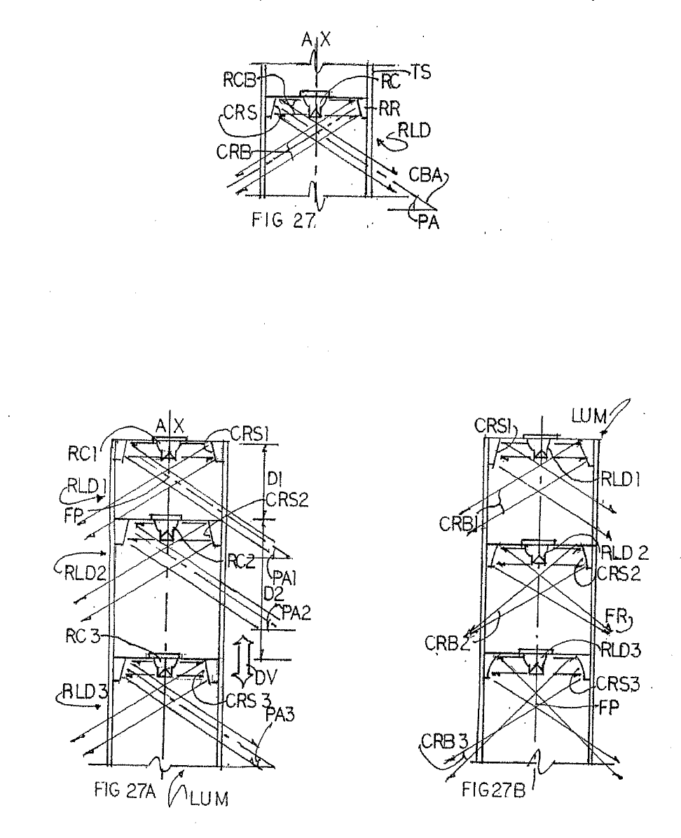

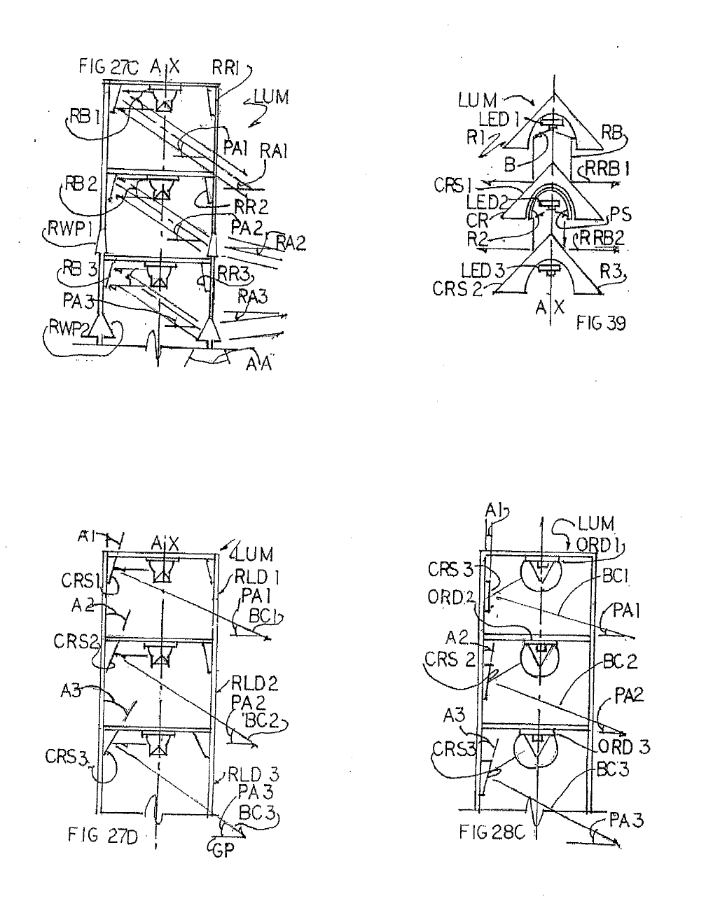

FIG. 27 is a cross-sectional diagram illustrating a single radial light distribution module containing a quasi-point light source such as an LED within a radially collimating ring optic RC, further surrounded by a reflective ring RR having a conically reflecting surface CRS. RC projects a radial collimating beam RCB onto the substantially specular conical surface CRS of RR which in turn reflects canted radial beam CRB1 which has a projected beam angle PA. PA is substantially focused on and passes through the axis AX of RC. The function of RLD is similarly discussed in my co-Pending patent application Ser. No. 11/034,395. RLD is supported within an optically transmissive tube TS.

FIG. 27A is a cross-sectional diagram of a luminaire LUM illustrating multiple RLD modules (shown in FIG. 27) RLD1, RLD2, and RLD3, all having similar radially collimating ring optics RC1, RC2, and RC3 respectively, as well as similar reflective ring surfaces CRS1, CRS2, and CRS3 respectively; therefore, the projected respected beam angles PA1, PA2, and PA3 are substantially equal. FIG. 27A further illustrates that the distance between RLD2 and RLD3 can be the same or different, varying in distance by shifting RLD1, RLD2, and RLD3 in relationship to each other along axis AX as illustrated by graphic arrow DV. Although FIG. 27A illustrates three RLDs, any number of RLDs may be employed along AX at equal and or varying distances from each other.

FIG. 27B is a cross-sectional diagram similar to that of FIG. 27A, illustrating RLD1, RLD2, and RLD3, each having differing cross-section curvatures of the reflecting ring's surfaced CRS1, being substantially flat (as in FIG. 1), CRS2 having a shallow concave surface (round, parabolic, or ellipsoidal), than CRS3. CRS1 reflects radial beam RB1 as canted beam CRB1, the cross-sectional divergence of which is substantially equal to RB1. CRS2 reflects RB2 as convergent, then divergent (in section) CRB2. CRS3 reflects RB3 as beam CRB3, which is more rapidly converging and then diverging than CRB2 due to the greater optical power of CRS3 than CRS2. The spacing and number of RLDs can vary as described in FIG. 27A due to the greater optical power of CRS3 than CRS2. The spacing and number of RLDs can vary as described in FIG. 27A.

FIG. 27C is a cross-sectional diagram illustration of a grouping of RLD modules as shown in FIG. 27A, with the addition of wedge prism rings RWP1 and RWP2, which are substantially concentric and share the same optical axis as RR1. Reflector rings RR2 and RR3 respectively and wedge prism rings RWP1 and RWP2 have the function of altering the radial beam pitch angle PA2 and PA3, as illustrated as RA2 and RA3. Angle A (AA) represents the cross-sectional angle between the faces of the wedge prism ring (PWR). The greater the angle, the greater the deviation in beam direction; the approximate function of a wedge prism is, for each degree of angle difference, the beam deviation equals one-half degree. Further, the wedge prism function is to bend the beam in the direction of the wider part of the prism.

FIG. 27D is a cross-sectional diagram of a partial luminaire LUM comprised of three RLD modules RLD1, RLD2, and RLD3 similar to those illustrated in FIG. 27. Although each of the reflective surfaces CRS1, CRS2, and CRS3 has a different respective cant angle A1, A2, and A3, A1 is most acute; therefore the angle PA1 (formed by the reflected beam angle BC1, and GP, a plane perpendicular to AX) is most acute. Cant angle A2 or CRS2 is less acute than A1 and therefore PA2 is less acute than PA1. It follows that if A3 is less acute than A2, then PA2 is less acute than PA2.

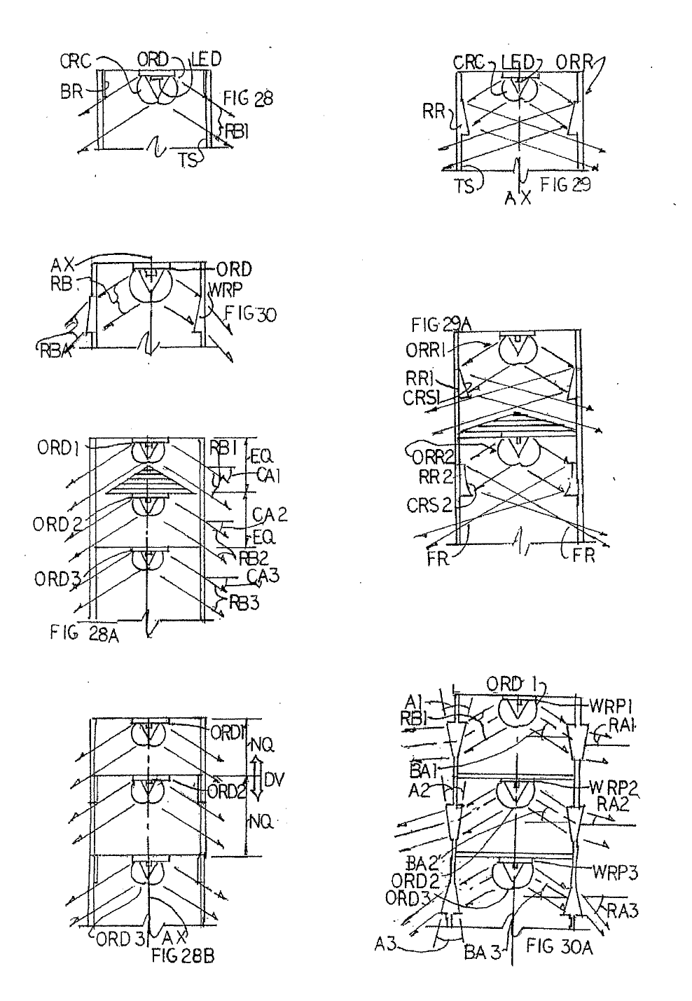

FIG. 28 is a cross-sectional diagram of an off-axis radial beam projector comprised of a quasi-point light source at least partially surrounded by an off-axis ring collimator CRC, projecting canted radial beam RB1 through a clear tubular support TS which is not essential for the light distribution provided by off-axis radial distributor ORD. Baffle ring BR blocks visual brightness emanating from CRC providing full cutoff of light that is not projected from the lens. The function of ORD is further elaborated and described in my co-pending application Ser. No. 11/034,395.

FIG. 28A is a cross-sectional diagram of an off-axis radial beam projector comprised of multiple ORDs, ORD1, ORD2, and ORD3, each projecting radial beams RB1, RB2, and RB3 respectively, each having substantially equal cant angles CA1, CA2, and CA3 respectively. The distance between ORD1 and ORD2, and the distance between ORD2 and ORD3, is equal. HST is a typical heat sing shown attached to LED of ORD2, shaped as a cone so as not to obstruct RB1.

FIG. 28B is a cross-sectional diagram of a device similar to that shown in FIG. 28A, differing in that the distance between ORD1 and ORD2 and the distance between ORD2 and ORD3 can be equal or be different by shifting one ORD in relation to another along axis AX.

FIG. 28B is a cross-sectional diagram of a partial luminaire LUM, comprised of ORD modules ORD1, ORD2, and ORD3, similar to those shown in FIG. 2. The relationship between the cant angles A1, A2, and A3 of CRS1, CRS2, and CRS3 respectively to the relationship of PA1, PA2, and PA3 is described and elaborated on in FIG. 27D.

FIG. 29 is a cross-sectional diagram of an off-axis radial beam projector similar to the one illustrated in FIG. 28 with the addition of reflector ring RR, the function and description of which is elaborated upon in FIG. 27.

FIG. 29A illustrates a radial beam projector containing two ORR modules ORR1 and ORR2 as described in FIG. 29. The cross-sectional surfaces of RR1 and RR2, CRS1 and CRS2 function and differ from each other in substantially the same way as CRS1 and CRS2 of FIG. 27A.

FIG. 30 is a cross-sectional diagram illustrating an ORD module similar to that shown in FIG. 28 with the addition of wedge prism ring WPR, which alters the cross-sectional direction of radial beam RB as radial beam RBA.

FIG. 30A is a cross-sectional diagram of a grouping of ORD modules, ORD1, ORD2, and ORD3, projecting RB1, RB2, and RB3 (all canted at the same angles) onto and through surrounding wedge prism rings WRP1, WRP2, and WRP3 respectively. Angle A1 of WRP1 is greater that A3 of WRP2 and therefore the variation between the sectional beam angle BA1 and its angle RA1 once refracted (bent) by RWP1 is greater than the variation between the sectional beam angle BA2 and its angle RA2 once refracted (bent) by RWP1. Further, the angle A3 of RWP3 is in the reverse direction of both A2 of RWP2 and A3 of RWP3 causing the cross-sectional difference between BA3 and its angle once refracted RA3 to be greater than the difference between BA1 and RA1, and BA3 and RA3. This is further elaborated on in FIG. 27 with the explanation of the function of the wedge prism (ring). The radial collimator RC of FIG. 27 can also be used in substitution of CRC in FIG. 30 with WPR of FIG. 4.

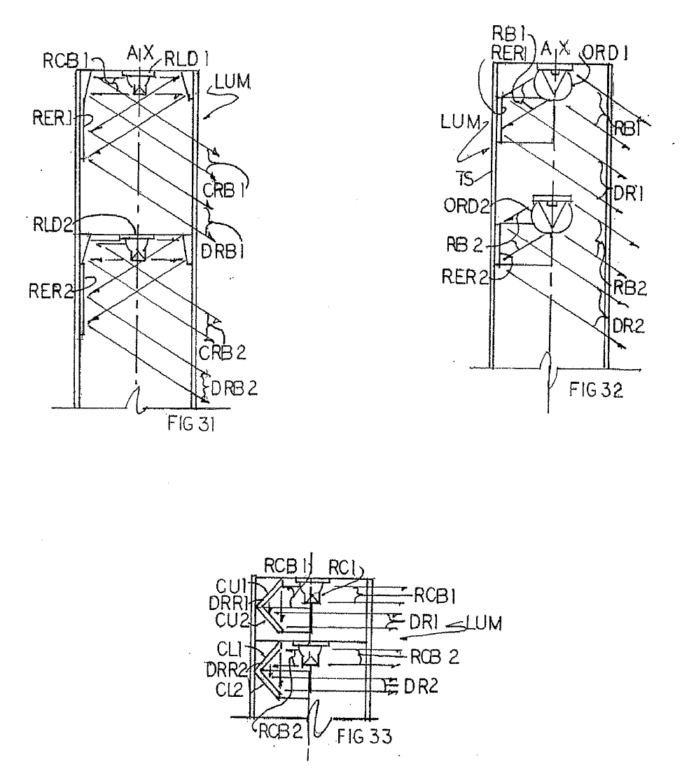

FIG. 31 is a cross-sectional diagram of two RLD modules, RLD1 and RLD2, similar in function to those of RLD of FIGS. 27, 27A, or FIG. 27B or FIG. 27C with the addition of retro reflector rings RER1 and RER2 respectively. RER1 and RER2 (which at least partially surround AX) reflect rays CRB1 and CRB2 as rays DRB1 and DRB2 respectively, which project in the same radial direction as CRB1 and CRB2 (that are not reflected by RER1 and RER2) respectively. Although 2 RCD modules are shown, any number of modules can be combined.

FIG. 32 is a cross-sectional diagram of an off axis radial beam projector comprising two ORD modules ORD1 AND ORD2 projecting canted radial beams RB1 and RB2 respectively. Reflector rings RER1 and RER2 which partially surround AX, reflect a portion of ORD1 and ORD2 as partial canted radial beams DR1 and DR2 respectively in the same radial direction as RB1 and RB2 respectively.

FIG. 33 is a cross-sectional diagram of two modules RC1 and RC2, each containing a quasi-point light source and a radially collimating ring optic similar to RC of FIG. 27, with the addition of compound reflectors DRR1 and DRR2 respectively. DRR2 and DRR2 are comprised of two truncated conical reflectors CU1 and CU2, and CL1 and CL2, joined at the large diameters so that rays RCB1 are reflected by CU1 onto CU2 and exit as rays DR1, which are projected in the same radial direction as rays CB1. Similarly rays RCB2 are reflected by CL1 onto CL2, which are reflected by CL3 as rays DR2.

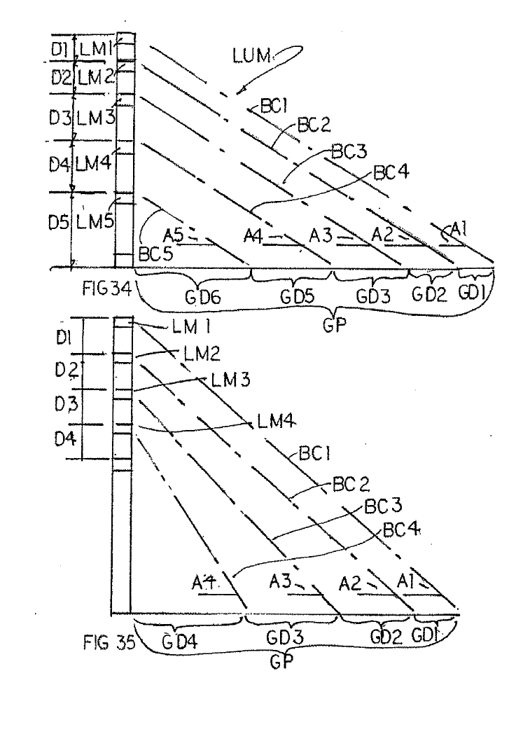

FIG. 34 is an elevation view diagram of a luminaire LUM comprised of radial light distribution modules LM1, LM2, LLM3 and LM5, mounted within tubular support TS. All the LM modules can be of a single type as any of the those shown in FIG. 27, 27A, 27B, 27C, 28, 28A, 28B, 29, 29A, 30, 30A, 31, 32, or 33, or be a combination of any of the radial light distribution modules shown; however, FIG. 34 is primarily illustrating the use of multiples of a single type of radial light distribution module. The distance D1, D2, D3, D4, and D5 between the modules increases between each of the modules as the distance of the modules decreases from the ground (surface) plane GP. Each module shown projects a radial beam having a beam center BC1, BC2, BC3, BC4, and BC5 respectively each at substantially the same angle A1, A2, A3, A4, and A5 to GP. Therefore, the distances between the modules D1, D2, D3, D4, and D5 are substantially the same ratios to the distances at GD1, GD2, GD3, GD4, and GD5 between the beam centers that strike GP. Referencing the reverse square law, it becomes necessary to provide an increasingly higher concentration of light further from the source, in order to maintain uniform brightness as the distance from the source increases. One way of achieving uniform brightness is to increase the density of projected beams as the distance from the source increases. This is clearly illustrated in the system described in this figure (34) and is further illustrated in FIGS. 27A and 27B.

FIG. 35 is an elevation view of a luminaire LUM mounted on a ground plane GP comprised of a grouping of radial light distribution modules LM1, LM2, LM3, and LM4 (mounted within TS). The distance D1, D2, D3, and D4 between and relative to the modules is substantially equal. Each LM module projects a radial beam (their respective centers are represented by BC1, BC2, BC3, and BC4) and are all projected at different angles (A1, A2, A3, and A4) to GP, the angles becoming progressively steeper to the ground plane from A1 through A4. One way this can be achieved by using the optical system described in FIGS. 27C, 30C, 27D, and Z1. Also differing reflective surfaces as represented by CRS1, CRS2, and CRS3 of FIG. 1B can be incorporated to change the beam spread of any or all the LM modules illustrated in FIG. 35 (or in FIG. 34). Generally, the LM module that is closest to the ground plane (LM4) would contain the CR5 surface that creates the widest beam divergence. Conversely, the LM module that is furthest from GP (LM1) would contain the CRS surface that creates the narrowest beam divergence. The substantially concentric areas of GP that receive projected light from LM1, LM3, LM3, and LM4 are GD1, GD2, GD3, and GD4 which become progressively wider as they get closer to the luminaire LUM.

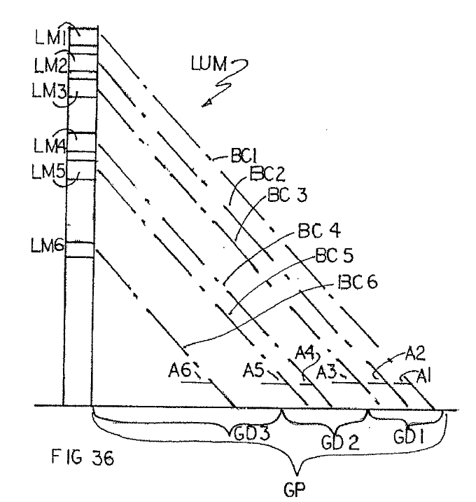

FIG. 36 is an elevation view of a luminaire LUM comprised of LM modules LM1, LM2, LM3, LM4, LM5, and LM6 projecting radial beams (represented by beam centers BC1, BC2, BC3, BC4, BC5, and BC6) onto GP. In order to achieve relatively even brightness throughout BP, LM1, LM2, and LM3 are stacked closely together, projecting beams A4 and A5 which are wider than LM1, LM2, and LM3. LM6 projects the widest beam, A6, onto GD3. BC1, BC2, BC3, BC4, BC5 and BC6 are all projected at equal angles represented by A, A1, A2, A3, A4, and A5. Although FIGS. 34, 35, and 36 illustrate LUMs mounted to GP, LUMs can be inverted and mounted to ceilings or be mounted to walls to spread indirect illumination.

FIG. 37 is a perspective view of a room RM containing four LUM luminaires. Each luminaire is comprised of one or several types of radial beam modules as described in FIGS. 27 through 33.

LUM1 is a ceiling-mounted luminaire IR having an up-light indirect distribution as illustrated and described in FIGS. 34, 35, and 36, and a down-light distribution DR provided by inverted LUM modules as those LUMs that provide the up-light distribution.

LUM2 is a luminaire mounted substantially perpendicular to wall W providing substantially 180° downward illumination on picture P. Lum2 is comprised of an optical system similar to that of either or FIGS. 31, 32, and 33.

LUM3 is a floor lamp providing up-light UL.

LUM4 is a table T lamp providing down-light to T.

FIG. 37 illustrates a limited number of total uses for the optical configurations in this Patent Application. Others include outdoor poles, bollards, path lights, wall packs, etc.

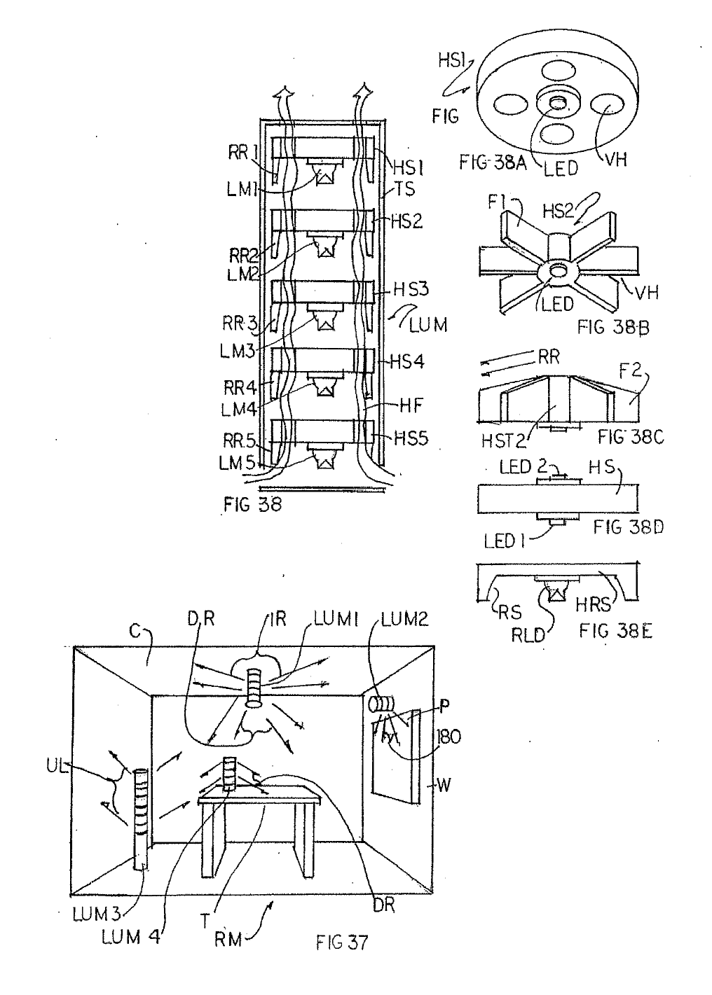

FIG. 38 is a sectional view of a luminaire LUM containing stacked groups of any combination of LMs or ORDs as described in FIGS. 27 through 33 or any stacked series of quasi-point sources such as LEDs. Module LM is mounted to a heat sink HS11, HS2, HS3, HS4, and HS5. In the case of LEDs, this is necessary to maintain lumen output and LED light. Each heat sink is constructed in such a way as to allow air to pass through from one to another represented by HF rising through HS5 to and through HS1. LUM of FIG. 38 is also comprised of tubular form TS which substantially encompasses the stack of modules LM1 through LM5 and their associated heat sinks HS1 through HS5. TS acts to provide a chimney effect for HF rising through LUM.

FIG. 38A is a three-dimensional diagram of one type of heat sink that may be utilized as an example of the luminaire shown in FIG. 38. The quasi-point source LED is mounted to HS1. Surrounding the mount of LED on HS1 are vent holes VH in HS1, allowing air to rise through.

FIG. 38B is a three-dimensional diagram of another type of heat sink HS2. HS2 contains a mount for an LED and radiating fins that allow air to pass through the space between the fins VS.

FIG. 38C is a side view of a heat sink HST2 which is similar to HS2 of FIG. 38B, differing in that the fins F2 are tapered so as not to obstruct canted radial beam RR projected by an LM or ORD (not shown).

FIG. 38D is a side view diagram of two quasi-point light sources LED1 and LED2 mounted back to back on the same flat heat sink HS.

FIG. 38E is a section view diagram of a heat sink HSR on which is mounted a quasi-point light source RLD that can or can not be surrounded by a collimating ring, further surrounded by a reflective surface RS.

FIG. 39 is a cross-sectional diagram of a luminaire comprised of 3 quasi-point light sources LED 1, LED2, and LED3, each at least partially surrounded by a reflector system R1, R2C, and R3 respectively. The function of reflective surface PS1 of R1 (which may be parabolic, ellipsoidal, or spherical) is to collect rays B emanating from LED1 and redirect them as RB onto the reflective surface CRS1 of substantially conical reflector CR which in turn reflects RB as radial beam RRB1. The function of reflectors R2 to R3 is similar to that described between R2 and R1. R2C is comprised of two elements, a light collimating element R2 similar in description and function to R1, and a conical reflecting element CR (both on the same optical axis). R3 is a single element combining a collecting surface RL3 and a substantially conical surface CRS2. CRS and or CRS2 can be straight in section (as shown) or convex or concave.

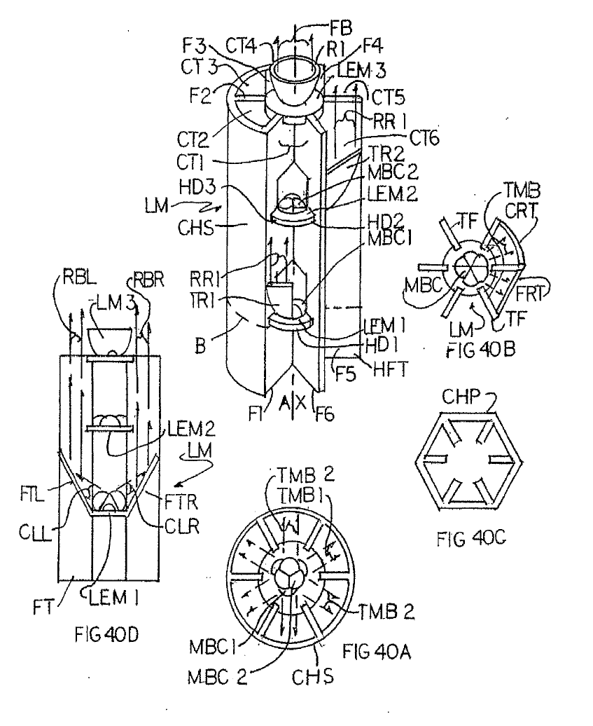

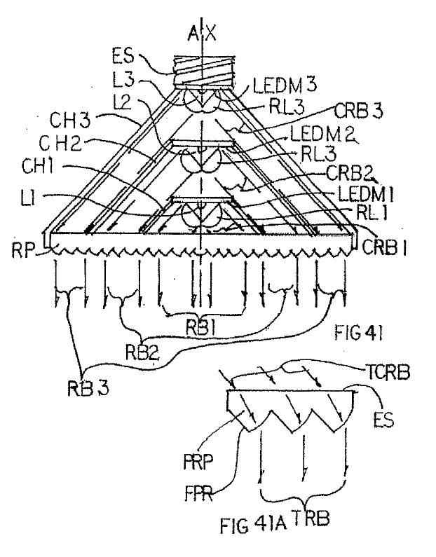

FIG. 40 is a three dimensional diagram of luminaire LM comprising 3 LED modules, LEM1, LEM2 and LEM3. LEM1 and LEM2 each comprise a single LED and each are surrounded by a multiple beam collimator MBC1 and MBC2 respectively. Both MBC1 and MBC2 divide the light from LEM1 and LEM2 respectively into groups of three typical beams TMB1 and TMB2 respectively (as shown in FIG. 40A which is a section view of FIG. 40). LM is further comprised of a heat sink structure CH5 constructed of a series of fins—F1, F2, F3, F4, F5, and F6 respectively, which radiate outward from and are thermally connected to the heat dissipation surfaces HD1, HD2, and HD3 of the LEDs. Besides providing heat dissipation for the LED modules the fins create a series of channels which surround a common axis on which the LEDs are located. F1 and F2 form typical channels CT2 and similarly F2 and F3 form CT3, F3 and F4 form CT4, F4 and F5 form CT5, F5 and F6 form CT6, and F5 and F1 form CT1. LEDM1 and LEDM2 are rotated about AX so that the beams TMB1 are projected into alternating channels CT1, CT3, and CT5, while beams TMB2 are projected into the alternating channels C2, C4 and C6. This arrangement provides a separate channel for each beam to enter. A reflector located within each channel is disposed to reflect and redirect each beam substantially through the channel in which the reflector is located. Although FIG. 40 illustrates two LEM modules, more modules may be employed each projecting two or greater than three beams. In turn, more or fewer channels can be assembled and disposed to receive a differing number of projected beams.

For graphic simplicity only one reflector associated with each module LEM1 and LEM2. TR1 and TR2 respectively are illustrated in this figure. TMB1 is reflected by TR1 as RR1 and TMB2 is reflected by TR2 as RR2. Any or all of fins F1, F2, F3, F4, F5, and F6 can be part of or connected to a substantially cylindrical or polyhedral tube CHS or CHP of FIG. 40C which would form an enclosure about any or all of the CT1 through CT6 channels. Also the typical surface RS of F1 through F6 as well as the internal surface of CJS can be specular so as to form a light guide for typical beams RR1 and RR2 to be contained within. Dotted line B indicates that the heat sink structure can be separated into individual heat sinks, each dissipating the heat form individual MBC modules.

FIG. 40A is a plan view section through FIG. 40 looking downward at MBC2 projecting the typical beams MBC2, and MBC1 below projecting typical beams TMB1.

FIG. 40B is a cross sectional view of a luminaire LM similar to that shown in FIG. 40, differing in that there is only one multiple beam projecting module MBC located substantially at the center of typical fins TF. In this embodiment MBC projects 6 typical beam TMB; one of the two shown is projected towards and reflected by a CRT, a reflection CRT having a concave surface, while the other TMB is projected towards FRT a reflector having substantially a flat surface.

FIG. 40C is a cross sectional view of a heat sink body CHP similar to that illustrated in FIG. 40, differing in that its outside shape is hexagonal rather than circular.

FIG. 40D is a vertical cross section view of a luminaire similar to that shown in FIG. 40 differing in that LEM1 and LEM2 have four individual collimators each. LEM1 is shown projecting two canted linear beams CLL and CLR which are reflected respectively by reflectors FTL and FTR as reflect4ed beams RBL and RBR and FTR as reflected beams RBL and RBR respectively. FIGS. 40 and 40D show an LED module LEM 3 which projects a linear beam FB. LEM3 is not necessary but can be used within this type of luminaire.

FIG. 41 is a cross sectional view of a light projecting device comprising three LEDM modules LEDM1, LEDM2, and LEDM3 each further comprising an LED light source L1, L2, and L3 repr0jects a canted radial beams respectively, each LED light source at least partially surrounded by a canted collimating ring lens RL1, RL2, and RL3 respectively. Each LEDM module LEDM1, LEDM2 and LEDM projects a canted radial beam CRB1, CRB2, and CRB3 respectively towards and onto refracting plate RP, which bends the rays of the canted radial beams into refracted beams RB1, RB2, and RB3 respectively, which in tern can be focused toward the optical axis AX, or be directed substantially parallel to the optical axis AX or away from and at an angle to the optical axis AX. The LEDM modules LEDM1 LEDM2, and LEDM3 are attached to heat sinks CHS1, CHS2, and CHS3 which are substantially conical, the sides of which are substantially canted at the same angle as the angle as the cant angle of the canted radial beams and disposed as to not obstruct the rays of the canted collimated beams. In another embodiment a multibeam collimator comprising individual collimating lenses that project individual beams at an angle to the axis AX may be used in place of a canted radial collimating ring lens.

FIG. 41A is a cross sectional partial view diagram of a refracting plate PRP which is one form of the refracting plate RP of FIG. 41, which comprises an entry face ES and fresnel type refracting rings FPR which bend canted radial beam rays TCRB at an angle to become beam rays TRB.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

1-57. (canceled)

58. A light projection device comprising:
a. a series of at least two stacked quasi point light sources sharing the same optical axis;
b. a multiple beam collimator surrounding at least two of said light sources, said collimator including at least two individual collimators geometrically arranged to project individual linear beams in a radially geometric pattern away from the optical axis of the quasi point light sources;
c. said individual collimators being spherical or aspheric lenses, or a combined spherical or aspherical lens and a reflector which is parabolic, ellipsoidal in section, and/or internally reflecting;
d: a geometric set of heat sink fins that are thermally attached to the quasi point light sources that radiate outwardly from the multibeam collimator the inner edges of which substantially face the optical axis and are disposed as to allow the individual lineal beam to pass between.

59. A light projection device as defined in claim 58 further comprising:
a geometric arrangement of reflecting surfaces outwardly from the multiple beam collimator and positioned at an angle to redirect the individual beams either substantially parallel to or at an angle to the common axis and to said heat sink of the stacked quasi point light sources, the combined arrangement of the multibeam collimators and their associated reflecting surfaces arranged and rotated about the common axis so that the reflecting surfaces of one stacked quasi point light source does not interfere with the redirected beams of another stacked quasi point light source.

60. A light projection device as defined in claim 59 with the reflecting surfaces located between the heat sink fins.

61. A light projection device as defined in claim 60 wherein the sides of the heat sink fins are reflective as to provide a guide to the reflected light.

62. A light projection device as defined in claim 59 where each LED comprises a set of heat sink fins wherein each set of fins are aligned so as to allow an individual reflected beam to pass through two or more sets.

63. A light projection device as in claim 59 wherein at least one reflector is at different distance from the beam projecting module than the other reflectors.

64. A light projection device comprising:
a. two collimating rings;
b. at least two stacked quasi point light emitting sources, each at least partially surrounded by a ring for radially directing collimated light from the sources and each sharing the same optical axis; and
c. reflecting rings disposed substantially concentric to the collimating rings, and redirecting the radially collimated light into a linearly collimated beam;
at least one of the collimating rings being surrounded by at least two ring reflectors, the inner most ring reflector having openings for portions of the radially projected beam to pass through onto the ring reflector surrounding said inner most ring.

65. (canceled)

68-70. (canceled)

71. A light projecting device comprising;
a. a stack of at least two quasi point light sources, each sharing the same optical axis;
b. an off axis canted radial ring collimator at least partially surrounding at least one of the quasi point light sources and projecting a canted radial beam;
c. a refracting surface disposed to intercept and redirect at least one canted radial beam;
the off axis ring collimator including individual collimating lenses that project individual collimated linear beams that are canted to the optical axis and projected onto the refracting surface.

72. A light projecting device as in claim 71 wherein a conical heat sink attached to at least one quasi point light source, the sides of the cone disposed at an angle substantially equal to that of the angle of the cant of the canted beams so as not to obstruct a beam adjacent to the heat sink.

73. A light projection device as in claim 60 wherein the outer edges of said heat sink fins connect to a tube that is substantially concentric to said optical axis.

74. A light projection device as in claim 73 wherein said tube is substantially composed of thermally conductive material and is thermally connected to said heat sink fins.

75. A light projection device as in claim 73 wherein the inner surface of said tube is reflective.
